(19) United States
(12) Patent Application Publication
(10) Pub. No.: US 2009/0132959 A1
(43) Pub. Date: May 21, 2009

(54) METHOD AND/OR SYSTEM FOR SCHEMA AND VIEW GENERATION

(76) Inventors: Jayavel Shanmugasundaram, Santa Clara, CA (US); Nitin Gupta, New Delhi (IN); George Levchenko, San Ramon, CA (US); Fan Yang, Mountain View, CA (US); Chaydar Botev, Ithaca, NY (US)

Correspondence Address: BERKELEY LAW & TECHNOLOGY GROUP LLP, 17933 NW EVERGREEN PARKWAY, SUITE 250, BEAVERTON, OR, 97006, US

(21) Appl. No.: 11/943,553

(22) Filed: Nov. 20, 2007

(51) Int. Cl. G06F 17/30; G06F 3/048

(52) U.S. Cl. 715/810; 707/102; 707/E17.044

(57) ABSTRACT

The subject matter disclosed herein relates to a method and/or system for generating schema responsive to user navigation patterns.

### BACKGROUND

1. Field

Subject matter disclosed herein relates to schema generation responsive to user navigation patterns.

2. Information

Services on the Internet may allow a user to create data-driven applications. Such applications may include database processing, project management tools, inventory database monitoring, to list a few examples. There are services that will host applications for users and allow the users to build the applications remotely. Because users' programming skills vary greatly, there's a desire to have application-creating tools that are simple to use, even for a user with little or no programming skills.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a schematic diagram of a system for developing applications, according to an embodiment.

FIG. 2 is a schematic diagram illustrating devices communicating via the Internet, according to an embodiment.

FIG. 3A is a schematic diagram of a computing platform, according to an embodiment.

FIG. 3B is a schematic diagram of a client, according to an embodiment.

FIG. 4 is a schematic diagram illustrating the architecture of a system for developing applications, according to an embodiment.

FIG. 5 is an example of a GUI for various application-building processes, according to an embodiment.

FIGS. 6A-6K show pages that may be displayed during the creation of an application, according to an embodiment.

FIGS. 7A-7E show schema during the creation of an application, according to an embodiment.

FIG. 8 is a schematic diagram illustrating a relationship between two entities in a portion of an entity-relationship model, according to an embodiment.

FIG. 9A is a flow diagram illustrating a process for monitoring inputs to a graphical user interface, according to an embodiment.

FIG. 9B is a flow diagram illustrating a process for establishing a relationship between two entities, according to an embodiment.

FIG. 10 is a schematic diagram illustrating a three-way relationship between entities, according to an embodiment.

FIG. 11 is a diagram illustrating an ER model, according to an embodiment.

### DETAILED DESCRIPTION

Some portions of the detailed description which follow are presented in terms of algorithms and/or symbolic representations of operations on data bits or binary digital signals stored within a computing system memory, such as a computer memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “associating”, “identifying”, “determining” and/or the like refer to the actions and/or processes of a computing platform, such as a computer or a similar electronic computing device, that manipulates and/or transforms data represented as physical electronic and/or magnetic quantities within the computing platform's memories, registers, and/or other information storage, transmission, and/or display devices.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

As the number of web-based application services offered over of the Internet increases, so to does the demand for very high-level programming languages. Some Internet users may have difficulty developing even simple web-based applications. This is primarily because present-day programming languages still require the user to learn many programming and application modeling concepts, ranging from, for example, trivial loops to database queries.

While some services and frameworks may provide a user with an interactive environment to create applications, each of them may either expose the user to the underlying and perhaps complex data model, requiring the user to interact with the data model, or require the user to code certain parts of the application's logic. Web-services and frameworks that don't have these requirements of the user may be severely restricted in the design of the application by not allowing useful functions and other tools, or they may only allow specific types of applications.

To help meet such a demand for very high-level programming languages that allow a less-programming-savvy user to build an application, embodiments described herein may allow a user having a minimum amount of programming skills to intuitively create applications graphically.

In one embodiment, a system and/or method to generate views, such as those in a display of a graphical user interface, may be based on a user's actions as the user develops an application. In another embodiment, a system and/or method may be used to generate schema based on page views. Application views and schema may be captured and described using an underlying application model, which may characterize a user's developed application.

In one embodiment, for example, a system, such as an application on a computer platform, may include such algorithms to build a user's application by observing the user's graphical inputs. Accordingly, the system may integrate these inputs into a model that may be represented in a graphical framework, giving the user a what-you-see-is-what-you-get (WYSIWYG) experience while ensuring that correct schema are automatically generated. Such a model used by the system may comprise an Entity-Relationship (ER) model.

An Entity-Relationship (ER) model, in one embodiment, may be used to represent objects, places, things, institutions, etc., as “entities”, and relationships between and/or among entities. In addition to comprising entities and relationships, the ER model may also associate with an entity one or more attributes.

In an embodiment, entities, attributes, and relationships in an ER model may represent data objects about which information is to be collected. Conversely, a data object may represent, or be associated with, entities, attributes, and relationships. The data objects may be defined within an application. Such an application may be stored and executed in a computing platform, for example. The data objects may comprise software code, a set of variables, and/or a pointer to a memory location that contains code and/or a set of variables, among other examples.

In one embodiment, entities may be associated with and/or represent recognizable concepts, either concrete or abstract, such as persons, places, things, or events that have relevance to a database. For example, students, courses, and assignments may all be considered to be entities. However, these are merely examples of concepts that may be represented by an entity and claimed subject matter is not limited in this respect.

In one particular example, a relationship may represent an association between and/or among two or more entities. For example, a relationship between entities students and courses may comprise attendance, in that students attend courses.

Attributes may describe and be associated with an entity. For example, an attribute may comprise a name of the entity student. Continuing with this example, a particular instance of an attribute may comprise a value, such as “John” is a value of an attribute name. The domain of an attribute may comprise a collection of possible values an attribute can have. The domain of name, for example, may comprise a character string.

According to an embodiment, an ER model may comprise multiple entities that may be associated according to one or more relationships. As explained above, an ER model may include attributes associated with entities. Attributes may also be associated with relationships, as explained below.

In an embodiment, a user may create, build, and modify a custom application using a web-based service, for example. To do this, the user may work remotely from the web-based service on a personal computer, a laptop, a cell phone, or a personal digital assistant (PDA), just to name a few examples. The web-based service may comprise a computer platform to host a system application that is used to create, build, and modify a custom application. In a specific embodiment, the computer platform may comprise a server while a user may use a browser on a client device communicating with the server via the Internet.

According to an embodiment, a system application may allow a user to create, build, and/or modify a custom application by correspondingly defining an ER model that represents the custom application. Such a system application may build and/or modify a custom application according to the ER model in response to the user's actions at a graphical user interface (GUI). The GUI may include a display, a keyboard, and a mouse, for example.

In one embodiment, an ER model may include data objects comprising information that may be recognized by processes executing on a computing platform as representing entities, relationships and/or attributes. A user may create or modify data objects and data associated with such data objects using a GUI. For example, a user clicking on an icon in a display may create or modify an entity, a relationship, or an attribute. In one embodiment, a data table or a form in the display may be an entity, while a column in the data table may comprise an attribute. Relationships between and/or among entities may be created based on navigation patterns established by the user as he interacts with the GUI. Accordingly, a system application may allow a user to associate entities with one another by relationships. The user, however, may not be aware of a relationship that he just created, since the system application may automatically create portions, such as relationships, of an ER model independent of the user's awareness. Of course, any number of ways to create entities, relationships, and attributes is possible, and claimed subject matter is not limited in this respect to illustrated embodiments.

In a particular embodiment, while building a custom application a user may create, build, or modify, in other words edit, an ER model working with a GUI in an apparent WYSIWYG graphical environment on a display. As such, the display may immediately reflect the user's editing inputs, and the display may also visually indicate how the ER model is modified. Thus, in a WYSIWYG context, the user may modify a visual appearance of the display while the ER model is modified. However, the user may not see many portions of the ER model since they may be hidden from the user and/or not displayed. Here, the user may be completely unaware of un-displayed and/or hidden portions of the ER model, which, advantageously, removes a potential burden of the user needing to know programming details while editing his custom application. Thus, in this sense, a user's editing environment is not truly WYSIWYG, though, conveniently, the user may not realize a difference.

In one particular embodiment, a display may show images of entities. While entities may be represented as a visual image on a GUI, for example, such entities may be represented as data objects in a user's custom application. Here, such entities may be represented as images comprising icons, data tables, and/or forms, to list a few possibilities. The user may affect the visual appearance of displayed images while editing the custom application, such as with a keyboard and/or a mouse, for example. Doing so may affect corresponding data objects, or relationships between and among the data objects in the custom application. Accordingly, affecting a visual appearance of the display images may affect the data objects that are associated with the corresponding entities.

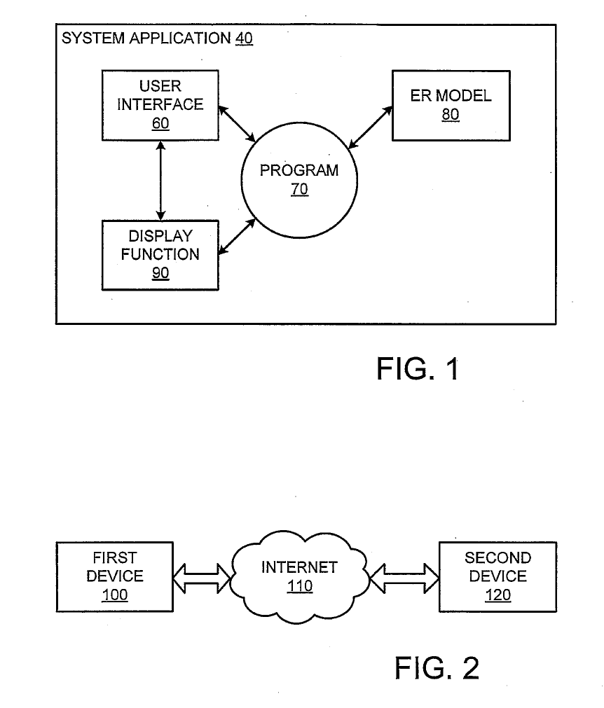

FIG. 1 is a schematic diagram of a system application 40, according to an embodiment. The system application 40 may comprise a program 70, a user interface 60, a display function 90, and an ER model 80. The user interface 60 may comprise a subroutine of the program 70 that allows communication over the Internet with a user at a remote location. For example, a user interface may operate a driver to output or receive data packets from a network or a user's browser. The ER model 80, as mentioned above, may be constructed and/or modified by program 70 responsive to a user's inputs at the GUI. The ER model 80 may comprise software that is represented as data objects within the system application 40. For example, if a user wishes to run his custom application, program 70 may compile the ER model 80 into executable code, which may then be run by the program 70 and/or the system application 40. Display function 90, which may be a part of the user interface 60, may comprise software that drives a user's GUI and receives data input at the GUI. System application 40 may generate a graphical view of the ER model 80, for example, by means of the user interface 60.

FIG. 2 is a schematic diagram illustrating devices communicating via the Internet, according to an embodiment. A first device 100 may communicate with a second device 120 through Internet 110 using any one of several communication protocols such as, for example TCP/IP. Second device 120 may be configured to allow a user to communicate, through the Internet 110, with the first device 100.

In a particular embodiment, the first device 100 may comprise a server that may host a system application 40 (FIG. 1). The second device 120 may comprise a client that may include a GUI to visually communicate with the server.

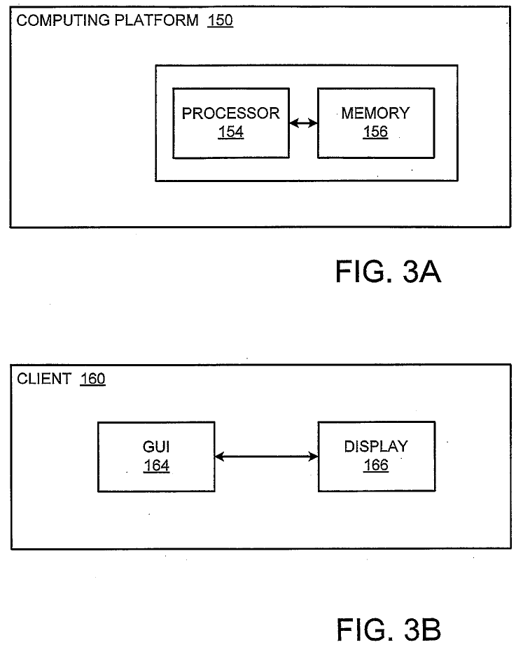

FIG. 3A is a schematic diagram of a computing platform 150, according to an embodiment. The computing platform 150 may include a processor 154 and a memory 156. A system application 40 may be executed on the processor 154 and an ER model 80 may be stored in the memory 156, for example. Referring to FIG. 2, a first device 100 may comprise a computing platform 150.

FIG. 3B is a schematic diagram showing detail of a second device according to a particular embodiment of second device 120. A client 160 may include a GUI 164 and an associated display 166, which may afford a user various means for providing information to and receiving information from a system application 40, such as a mouse and a keyboard (not shown). Client 160 may also include means for an Internet connection control, such as a modem, a network adapter, and a browser (not shown). A GUI 164 may include a keyboard and a mouse, both of which are not shown, to allow the user to interact with the system application 40 and the first device 100 in general.

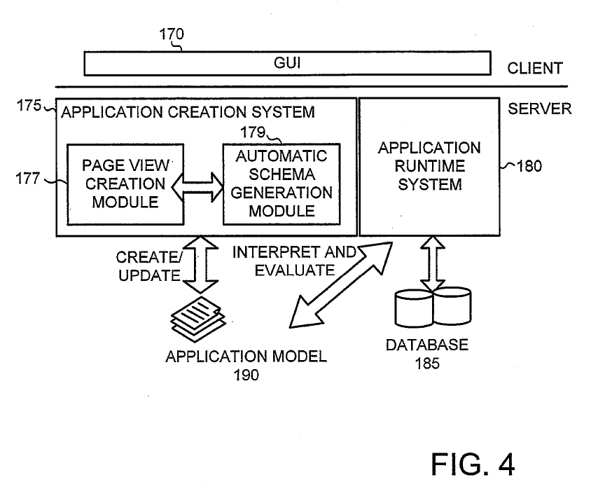

FIG. 4 is a schematic diagram illustrating the architecture of a system for developing applications by running the system application 40, for example, according to an embodiment. In a front-end, the system may comprise a GUI 170, which may be similar to the GUI 164 included in the client 160 of the embodiment of FIG. 3B, for example. As a user develops an application, the system, utilizing the system application 40, may automatically generate schema and application logic, and store this information in a back-end, which may be a server, such as the computing platform 150 shown in FIG. 3A. A user may run the application at the same time as they are editing it.

The system back-end may include two subsystems: an application creation system 175 and an application runtime system 180. The application creation system 175 may create and update an application model 190, which may comprise an ER model 80, as shown in FIG. 1. The application model 190 may include specifications of page views, application logic, and database schema, for example, based on a user's actions. In turn, the application creation system 175 may include a page view creation module 177 that may provide an interface for creating and updating a web page, for example. A user's actions at the front-end for creating and editing page views may be translated into commands in the page view creation module 177. The application creation system 175 may also include an automatic schema generation module 179 that may automatically generate appropriate database schema from page views.

Continuing to refer to FIG. 4, a system may build page views and generate schema by an iterative procedure. New views may be built by navigating existing schema, and schema may be implicitly updated when the user updates a page view. Application model 190 created by application creation system 175 may be stored in a memory, such as memory 156 shown in FIG. 3A. Application runtime system 180 may load application model 190 from memory and serve an end user's request by interpreting and evaluating application model 190. Application runtime system 180 may use a back-end database 185 to manage a state of application model 190.

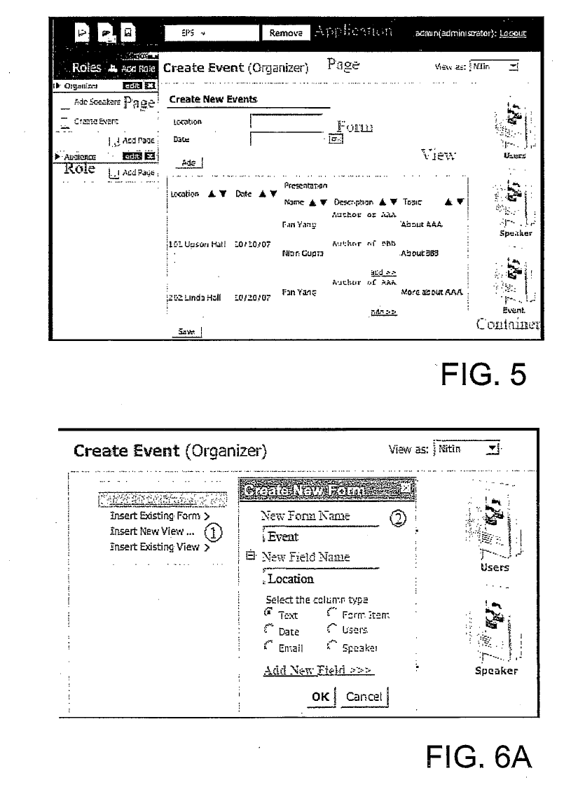

FIG. 5 is an example of a GUI for various application-building processes, according to an embodiment. A user, either a developing user or an end-user, may work with in the interactive display of FIG. 5, such as that provided by GUI 170 in FIG. 4. A system application, in a specific embodiment, may enable a user to create and manage multiple applications. Each application may be pre-populated with a list of users. Referring to FIG. 5, for example, users may be initialized to be all members of a certain user's group. Also, users of applications may be associated with different roles. Users in different roles may view pages with different content and different allowed actions. Users in each role may access a set of pages which may contain one or more forms and views, for example. Users may use forms to enter new data. Forms may be associated with logic to update database tables. The application may support many types of form components, such as input fields and drop down boxes, for example.

A user may view and update the state of the application using views. Views on data may be presented as nested tables, for example. Other formats such as un-nested lists and charts may be supported as well.

A container may correspond to entities in an application. A user building an application, such as a developer, may be allowed to view a container, wherein an end-user, who merely runs and uses the already-developed application, may not view a container. Containers may be used as a visual aid for developing applications. Containers may be automatically created when developing users add new forms and views to pages.

The following example illustrates an application of an embodiment applied to a book club organization. Of course, this example is only for illustrative purposes and in no way implies any limitation to the uses to which application embodiments may be applied. One skilled in the art will realize that an unlimited number of variations to the following descriptions is possible, and that the example and the accompanying figures are merely to illustrate a particular implementation of what may be displayed and performed according to one or more embodiments.

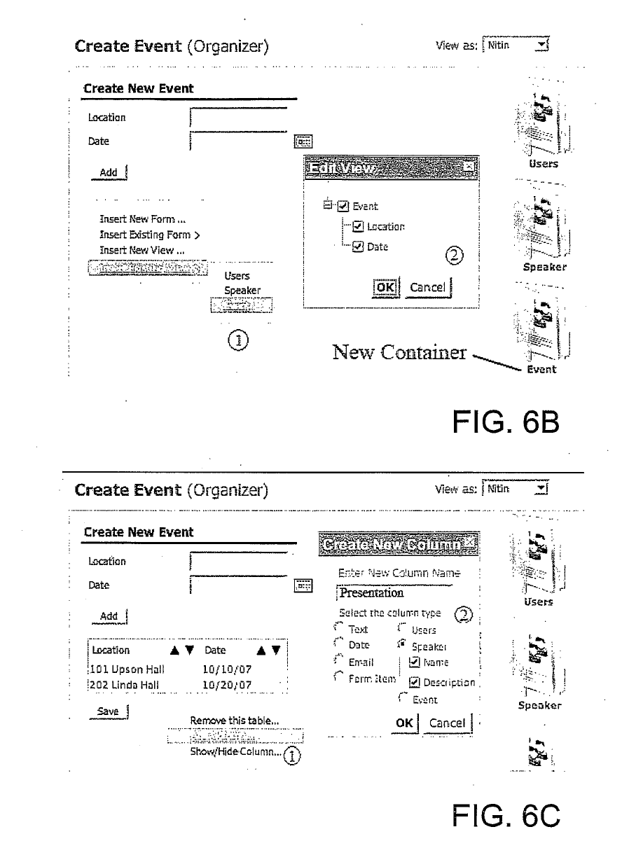

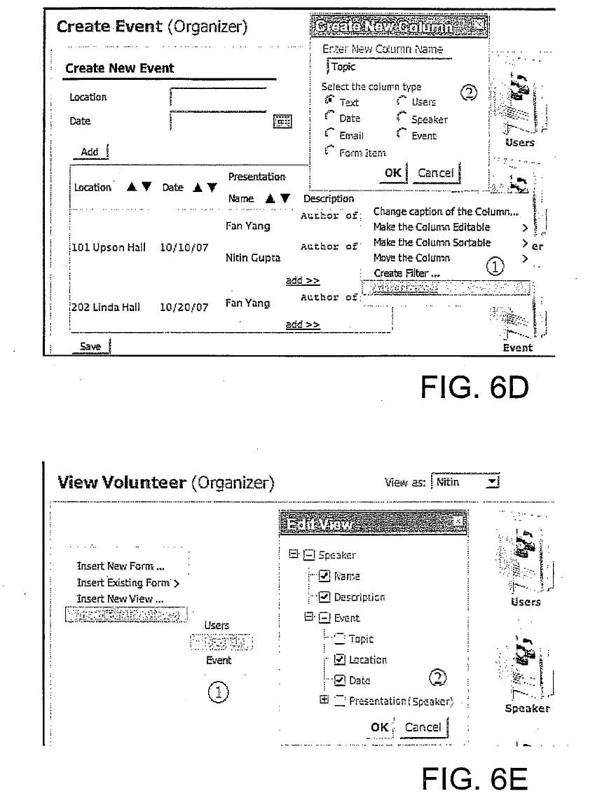

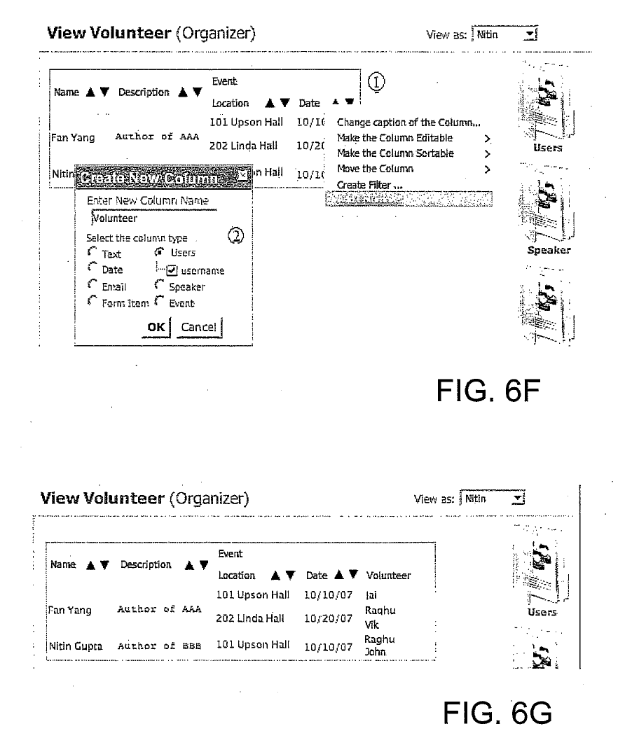

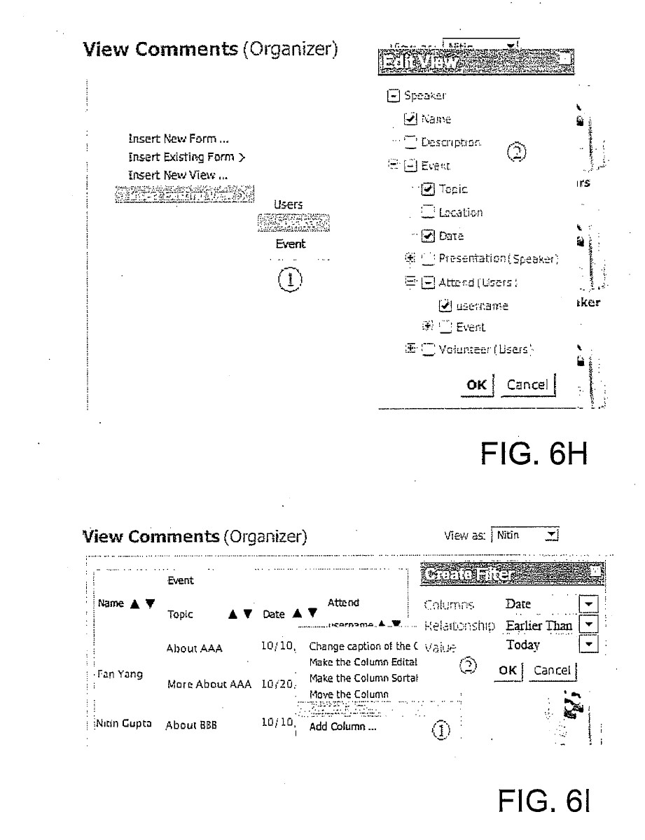

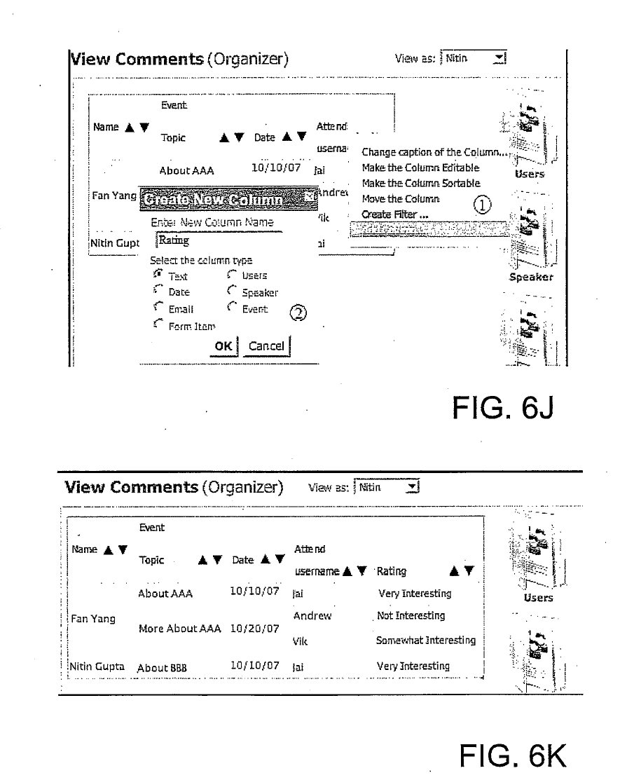

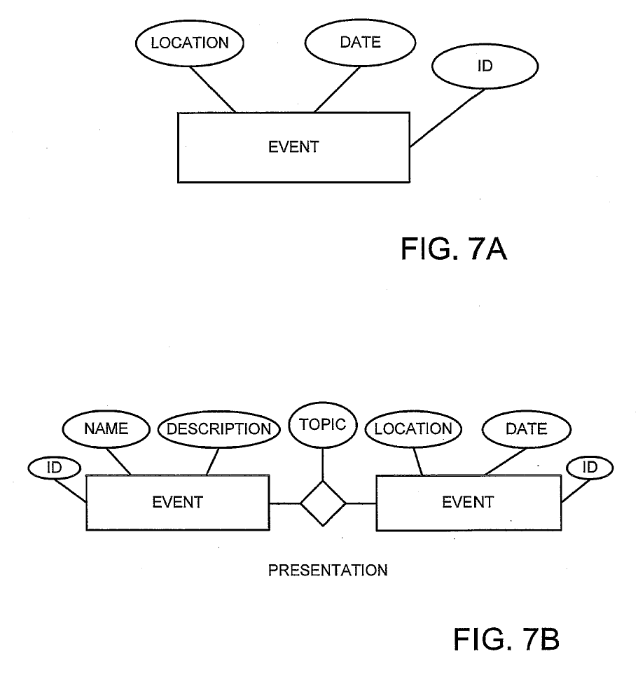

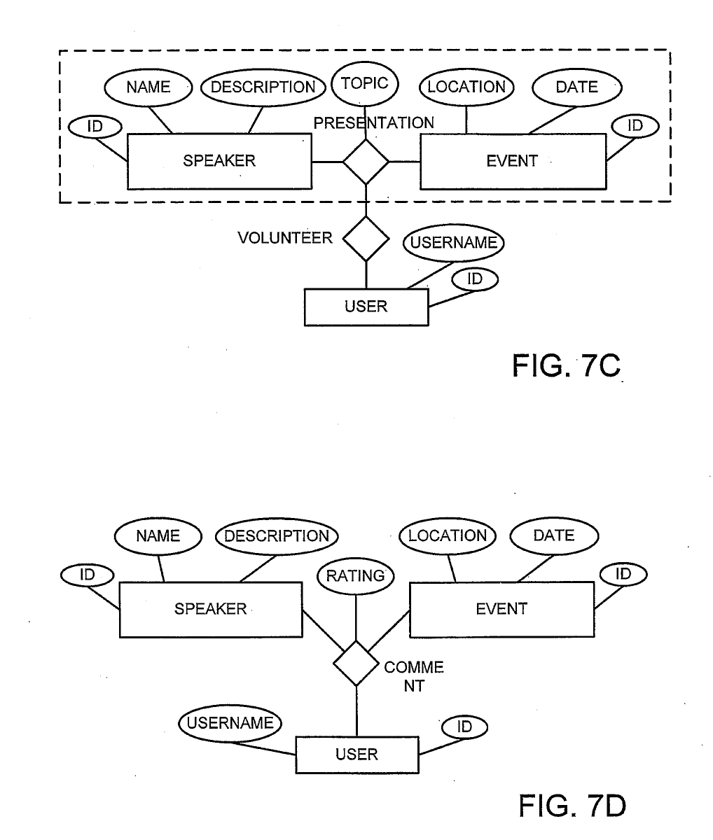

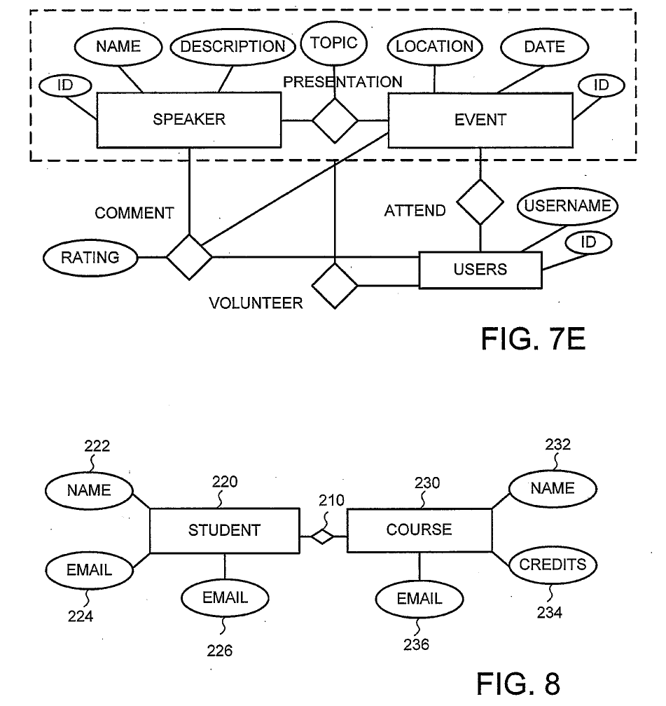

FIGS. 6A-6K show screen shots that may be displayed during the creation of an application; FIGS. 7A-7E show schema during the creation of such an application; and Appendix A and B show pseudo code for implementation of view generation and schema generation according to one particular embodiment. Most of the FIGS. 6A-6K, include circled numbers 1 and 2. In the following description, the portion of the figure with the circled number will be referred to as “part”, such as “FIG. 6B, part 1”.

A book club may wish to organize regular events with invited speakers to give presentations on different books, for example. Consequently, book club members may decide to build their own custom event planning system (EPS).

Here may be two roles in an EPS: organizers and attendees, for example. Organizers may add candidate speakers, create events, and view registered attendees and their feedback after each event. Attendees may register for an event and provide feedback for each speaker. Attendees may also volunteer to help speakers in each event, for example, by providing transportation.

Using a system application such as that of the embodiment of FIG. 1, book club members may create an application EPS with a pre-populated container named “Users”, which may contain a data entry for every book club member, and a container named “Speaker” that may contain information about speakers.

Using a display such as the one shown in FIG. 6A, an organizer may create an events page to create new events, add speakers, and add presentation topics for each event. To do this, the organizer may create a form named “Event” that includes fields “Location” and “Date”. The system application may update schema resulting in the creation of a new entity “Event” with attributes Location” and “Date”. The schema may be similar to that shown in FIG. 7A. A resulting form is shown in FIG. 6B

As in FIG. 6B, part 1, an organizer may add a view over “Event” and select columns in a drop-down menu as shown in FIG. 6B, part 2, for example, to show the view. The organizer may then click beside the view, as in FIG. 6C, part 1 to add a new column named “Presentation” of the type “Speaker” and select columns in “Speaker” to show in the view, as in FIG. 6C, part 2. The system application may then update schema and create a two-way relationship named “Presentation” between “Event” and “Speaker” entities.

Using a view such as the one shown in FIG. 6D, part 1, an organizer may click on a nested table for “Presentation” and add a new column named “Topic”, as in FIG. 6D, part 2. A resulting display page may be as shown in FIG. 5, for example. As the system application updates schema a topic attribute may be added to the “Presentation” relationship. Such schema may be similar to that presented in FIG. 7B.

Organizers may view a volunteer page to see who volunteered to assist speakers, for example, as shown in FIG. 6G. Volunteers may be grouped for each speaker per event. The organizer may add a view over “Speaker” and “Event” by navigating from “Speaker” to “Event” in a schema navigation menu, as shown for example in FIG. 6E. A possible resulting view is shown in FIG. 6F, part 1. The organizer may click on a nested table for “Event” and add a column “Volunteer” of type “Users”, as in FIG. 6F, part 2. During an automatic schema update, an aggregation of “Speaker” and “Event” may be created. A two-way relationship between the new aggregation and the “Users” entity may be created, which may be similar to that shown in FIG. 7C.

Organizers may view a comments page to view comments from attendees for each speaker of the events, for example, as in FIG. 6K. The view may only show events that are completed. To do this, an organizer may add a view over “User”, “Event”, and “Speaker” by navigating through a schema navigation menu as in FIG. 6H, part 1. The resulting view may be similar to that shown in FIG. 6H, part 2. The organizer may then click on a “Date” column, as in FIG. 6I, part 1, to create a filter with the date of an event that is earlier than the current date, as in FIG. 6I, part 2. Finally, the organizer may click on an “Attend” nested table, as in FIG. 6J, part 1, to create a new column named “Rating”, as shown in FIG. 6J, part 2. An automatic schema updating may then create a three-way relationship with an attribute “Rating”, which connects “Speaker”, “Event”, and “Users”, as shown in FIG. 7D.

From the example above, one may see that, according to a specific embodiment, a system application may provide a WYSIWYG environment so that developing users may view the developed application the same way as the end users. An example of a final schema that may be generated in the example described above is shown in FIG. 7E. Using a schema navigation menu, as in FIGS. 6B, 6E, and 6H, parts 2, developing users may easily navigate through automatically generated schema and construct complex views, such as FIGS. 5, 6G, and 6K, graphically without knowledge about database schema and programming.

Appendix A and B show pseudo code for view generation and schema generation in one particular implementation for the example described above, according to an embodiment. It should be understood, however, that this is merely one implementation and that other implementations may be used without deviating from claimed subject matter. A schema navigation menu may be a tree-structured menu whose root is an entity in an E-R graph. The construction of a menu may be initiated when a developer selects the root entity, as in FIGS. 6B, 6E, and 6H, parts 1, for example. The options and structure of the menu may be determined by the attributes and relationships among entities in the E-R graph, as in FIGS. 6B, 6E, and 6H, parts 2, for example. At each level of the menu tree, the list of checkable options may be given by Appendix A, for example. One skilled in the art will recognize that there may be a number of variations to pseudo code of Appendix A, and this merely shows an example.

An automatic schema generation module, as shown in FIG. 4, for example, may generate complex schema based on just two simple actions of the developing using: creating forms/views, and adding fields/columns to forms/views. The graphical context (position in form/view) of these two actions may be powerful enough to construct arbitrarily complex schema, including those with n-way relationships and aggregations. One possible schema generation algorithm is shown in an implementation shown in Appendix B. One skilled in the art will recognize that there may be a number of variations to the pseudo code of Appendix B, and this merely shows an example.

Beginning with another example, FIG. 8 is a schematic diagram of a portion of an ER model 200 illustrating an example of a relationship between two entities, according to an embodiment. This ER model may correspond to a custom application, for example. Entities, relationships, and attributes may be represented by data objects in the custom application. In a particular illustrated embodiment, such a custom application may be directed to using a school's database, just to describe one particular example. Such a database may be used to keep track of courses, enrolled students, student grades, and so on.

A user may create and/or build a custom application using a client 160 having a GUI 164 remotely from a computing platform 150 via Internet 110, as shown, for example, in FIGS. 2-4. A system application 40 (FIG. 1) may construct and/or modify an ER model 200 corresponding to the custom application by tracking the user's interaction with the system application 40 through the GUI 164. For example, the system application 40 may allow the user to choose, such as by a mouse click, a graphical view of an entity Student 220. Within that graphical view, a user may subsequently choose to add a new attribute, such as Name 222. For instance, the entity Student 220 may be represented as a data table in a display 166. The data table may include a number of columns, wherein each column includes data to describe each row of students that comprise a first column. The columns, which may be associated with attributes, may each have an associated column heading label. Accordingly, the column heading labels, in this example, may be associated with attributes of the entity Student 220, may be “name”, “enrolled”, “test score sum”, and “attendance”, to list some possibilities. Each element of a column may be a value of an attribute associated with that column. For example, “John Smith” is one value of an attribute “name”, and “name” is a column in a data table that is the entity Student 220.

Continuing with the example above, the user may select a particular location with respect to the data table to cause a drop-down menu to appear. Choices in the drop-down menu may include delete column, add column, and so on, for example. Clicking on add column may be akin to adding an attribute. The user at this time may also establish a name for the new attribute. Of course, any number of ways to create and build a custom application, to add attributes, and so on is possible, and claimed subject matter is not limited in this respect to the illustrated embodiments.

ER model in FIG. 8, which may be just a portion of a large ER model, shows entities Student 220 and Course 230, their mutual relationship 210, and respective attributes of the entities. Specifically, Name 222 and Email 224 are attributes of entity Student 220, and Name 232 and Credits 234 are attributes of entity Course 230. Accordingly, Name 222 and Email 224 are properties that describe entity Student 220, and Name 232 and Credits 234 are properties that describe the entity Course 230.

As mentioned above, entities may be associated with one another according to a relationship. In FIG. 8, for example, entities student 220 and course 230 are associated with one another according to the relationship 210. A user may assign a name to a relationship 210, such as “enrolled”, since student 220 may be enrolled in course 230.

Though an ER model may be built and/or modified in response to a user's click and navigation patterns via a GUI, a user may be intentionally left unaware of substantial portions of the ER model. In an embodiment, for example, relationships may be created only implicitly, as will be explained shortly, and they may not be exposed or revealed to the user.

In an embodiment, a system application 40 may automatically create a relationship between two entities. For example, such a relationship may occur if a user includes an attribute with a first entity. A system application 40 may create the relationship if the system application 40 recognizes the attribute as a second entity that is already included in an ER model. For example, referring to FIG. 8, the ER model 200 may have been constructed with the user adding the entity Course 230 as an attribute, shown as the attribute Course 226, of the entity student 220. This user action may have created the relationship 210. Thus, a single request by the user for an additional attribute resulted in a new relationship 210 and the creation of two new attributes—attribute Course 226 associated with the entity Student 220, and attribute Student 236 associated with the entity Course 230.

As explained above, a user may interact with a system application 40, which may be executed and stored at a first device 100, through the GUI 164 at a second device 120 (FIGS. 1-4). Receiving user input at the GUI 164 may affect system application 40 that defines data objects associated with entities. GUI 164 may allow the user to visually associate an attribute with an entity in a display 166. In response, system application 40 may establish a relationship in an ER model between the entities based, at least in part, on the visual association. One or more of the entities and the relationship may be hidden and/or not shown on the display 166.

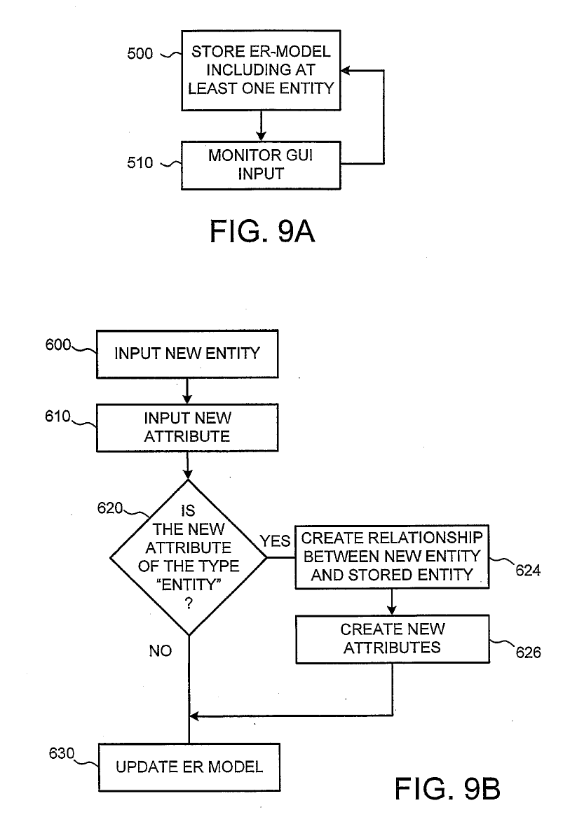

FIG. 9A is a flow diagram illustrating a process for monitoring GUI input, and FIG. 9B is a flow diagram illustrating a process for creating a relationship between two entities, according to an embodiment.

Referring to FIG. 9A, actions (explained below) depicted in blocks 500 and 510 may be performed by a computing platform that is remote from a GUI of a client platform, such as that shown in FIGS. 2-4 illustrating a first device 100 remote from GUI 164 at second device 120. Of course, any number of configurations is possible, and claimed subject matter is not limited in this respect to the illustrated embodiments.

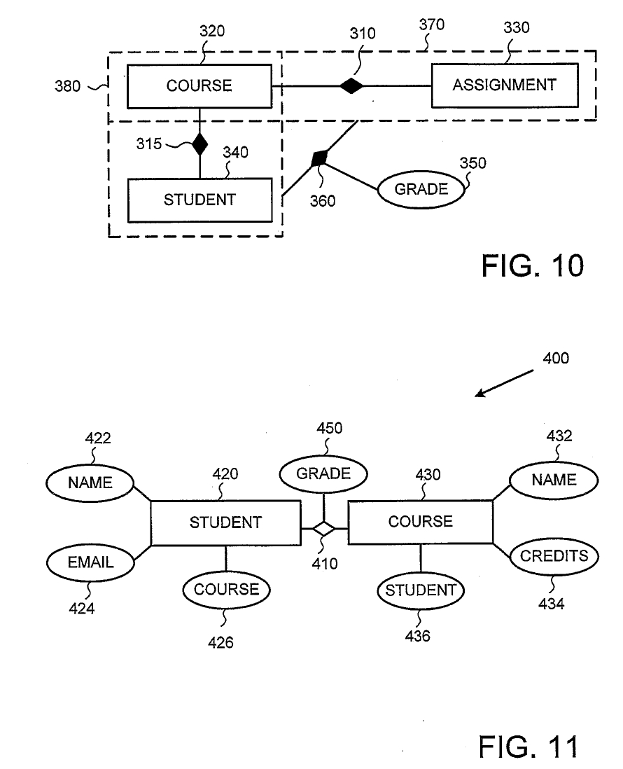

Accordingly, in an embodiment shown at least in part by FIGS. 2-4, at block 500, an ER model may be generated by system application 40 that is executed and stored by the first device 100 that may include the processor 104 and the memory 106. Here, an ER model may represent at least one entity as a data object. At block 510, first device 100 may monitor actions of a user interacting with the GUI 164 at second device 120. Actions of blocks 500 and 510 may be repeated in parallel with actions performed at the GUI 164, such as those actions to be described in FIG. 10B. In this way, the user may develop and/or modify the ER model on-the-fly in a graphical process.

Referring to FIG. 9B, a relationship between two entities may be created by associating one of the entities with an attribute. At block 600, a user, interacting with the GUI 164, may create an icon or other display object that is associated with a new entity in an ER model. This may be done, for example, by selecting a display object or icon, typing a name for the new entity, or both. The display object or icon may be, or represent, a data table or a form, which may prompt additional data entry, for example. At block 610, the user may create an icon or other display object that is associated with a new attribute to associate with the new entity in the ER model. This may be done, for example, by selecting a display object or icon that may represent the new entity, and typing a name for the new attribute. At block 620, system application 40, at first device 100, may determine whether the new attribute has the same name as an entity that already exists in the ER model. If so, then the new attribute may be considered to be an “entity” type.

If the determination at block 620 results in a ‘no’, then the ER model may be updated at block 630 by system application 40. If the determination at block 620 results in a ‘yes’, then, at block 624, the system application 40 may create a relationship between the new entity and the previously existing entity that corresponds with the new attribute. This relationship may then become a part of the ER model. The relationship may be hidden and/or not displayed, and the user may not be aware of the relationship's creation.

At block 626, a new system-created attribute may be created by the system application 40 in response to the user inputting the new attribute, at block 610, of the entity type. The new system-created attribute, which matches the previously existing entity, may correspond to the new entity inputted by the user in block 600. For example, referring to FIG. 8, ER model 200 may have been constructed with actions depicted in FIG. 9B. In which case, for example, a previously existing entity may be Course 230, a user-created new entity, from block 600, may be Student 220, and a user-created new attribute, from block 610, maybe Course 226. Accordingly, at block 626, a new system-created attribute Student 236, which matches previously existing entity Student 220, may correspond to the new entity Course 226 inputted by the user in block 600.

At block 630, a system application may update an ER model. Updates to the ER model may occur continuously or incrementally, and are not limited to actions depicted in FIG. 9B or any other figure.

In an embodiment, an ER model may allow relationships to have attributes, and the system application 40 facilitates this association. Referring again to FIG. 8 to illustrate an example, an attribute may comprise “grade”, which is neither specific to the entity Student 220 nor the entity Course 230, but instead is useable only if both Student 220 and Course 230 are specified with the “grade” attribute. Therefore, if a user attempts to add the “grade” attribute to the entity Course 230, for instance, then the system application 40, as it builds the ER model 200, recognizes that the “grade” attribute should instead be associated with the relationship 210 between the entity Student 220 and the entity Course 230.

Though a system application 40 may construct and/or modify an ER model 200 in response to a user's actions, system application 40 may prevent exposing details of the ER model to the user, as discussed above. For example, a user above may have chosen to include the “grade” attribute with the entity Course 230, and the system application 40 instead included the “grade” attribute with the student/course relationship 210. Again, the user may be unaware of this change as the relationship is hidden and/or not displayed. In other words, while the “grade” attribute and the entity Course 230 are displayed in the display 126, the student/course relationship 210 and its “grade” attribute may be hidden from the display. The user may be completely unaware of the un-displayed portions of the ER model which, advantageously, removes a potential burden of the user needing to know programming details while editing his custom application.

FIG. 10 is a schematic diagram illustrating a three-way relationship among entities, according to an embodiment. System application 40 may allow the creation of n-way relationships, where n is an integer. An n-way relationship relates n entities. Note that an ER model 300 may allow an entity to repeat multiple times in an n-way relationship.

Referring to FIG. 10, the ER model 300 defines two 2-way relationships 370 and 380. The two 2-way relationships comprise the entities Student 340, Course 320, and Assignment 330. Assume that a user has constructed, using any of the procedures mentioned above, or other procedures that one skilled in the art may realize, two 2-way relationships. These two 2-way relationships are the relationship Enrolled 315 between Student 340 and Course 320, and the relationship Evaluation 310 between Course 320 and Assignment 330. Extending the “grade” attribute example above, a user may include such an attribute Grade 350, but Grade 350 is only relevant if all three entities—Course 320, and Assignment 330, and Student 340—are present. Also consider that if there are two or more 2-way relationships present, then a 3-way relationship among three entities may include multiple contexts. Accordingly, system application 40 may handle such situations. For example, if the Student 340 and Course 320 entities are related by temporarily enrolled and permanently enrolled relationships, then the attribute Grade 350 may only make sense in the context of the permanently enrolled relationship.

In an embodiment, system application 40 may allow a user to create n-way relationships without exposing the user to such relationships. Again referring to FIG. 10, the user may associate attributes with any of the three entities involved or the two relationships. For example, the result of an attribute association with the entity student 340, the relationship enrolled 315, and the entity course 320 may be unaffected by including a new relationship 360 involving the entity assignment 330. However, if the user attempts to add an attribute to either the relationship evaluation 310 or assignment 330, then the system application 40 may determine this user action to actually be best served by instead adding an attribute to a 3-way relationship relating enrolled 315 and evaluation 310.

To explain this example further, if the user's action invokes an event on either Student 340, Enrolled 315, or Course 320, then system application 40 may simply follow though with the user's intention. But if the user's action invokes an event on either Assignment 330 or Evaluation 310, and if a relationship 360 does not already exist between the aggregate entity of Enrolled 315 and Evaluation 310, system application 40 may construct such a relationship 360 and add an attribute to this new relationship 360. Otherwise the system application 40 may add the attribute to the existing relationship 360 that relates these two aggregate identities. To this end, system application 40 may include a function that checks whether or not there is an object in the ER model 300 relating two aggregate entities (which may be effectively relationships such as 370 and 380 in the example above).

System application 40 may include a display function 90 for displaying portions of an ER model 80 at a GUI. This function may be associated with the user interface 60 (FIG. 1) to communicate display instructions with the second device 120. Display function 90 may be configured to selectively display portions of the ER model 80 that do not include complexities included in the ER model 80. For example, system application 40 may not expose a user to relationships in the ER model 80, leaving only a graphical display that is simple for the user to comprehend and work with.

FIG. 11 is a diagram of an ER model 400, according to an embodiment. Regarding display representations of the ER model 400, there may be many possible views. In other words, a display may show various portions of an ER model 400. For example, the display may show a view of the ER model 400 comprising a visual image over just the student entity 420. Or, the display may show another view comprising just the course entity 430. Still another view shown by the display may comprise an entire ER model 400. A displayed view may be further refined by including combinations of entities, such as, for example, the student entity 420, the course entity 430, and their associated relationship. However, not all of these views may be relevant to an ER model 400. For example, a view over just a relationship may not make sense unless the associated two entities are also part of the view. A user may be provided with all relevant information, as presented on a display for example, without the need to expose him explicitly to an ER model 400.

A user may begin creating a view of the ER model 400 by selecting one of the entities from the ER model 400. In an embodiment, the page view creation module 177 of FIG. 4 may be utilized. This entity may be called a root entity, for example. Such a user may then follow any relationship from the root entity to perform a join with a related entity, called the relative. The system application 40 may then expose attributes of the relative to the user to allow the user to project a view on this entity. Given this user navigation pattern, the attributes that belong to the relationship relating the root and the relative may be projected onto the relative, thus preventing an explicit display of the relationship to the user. For example, the user may wish to see all courses that each student is enrolled in, and their grades for the courses. The root entity is student 420 and the relative entity is course 430. The grade attribute 450 may therefore be projected onto course 430 as an additional attribute.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

1. A method comprising:
receiving user input at a graphical user interface (GUI) to affect an application that defines data objects associated with two or more entities including a first entity and a second entity;
visually associating at the GUI an attribute with the first entity in a display in response to said user input; and
establishing a relationship in the application between and/or among the two or more entities including the first entity and the second entity based, at least in part, on the visual association, wherein the second entity and the relationship are hidden from the display.

2. The method of claim 1, further comprising storing the application on a computing platform that is remote from the GUI.

3. The method of claim 2, wherein the user input is received by the server via the Internet.

4. The method of claim 1, wherein the user input includes a form that defines the two or more entities.

5. The method of claim 1, wherein the user input includes a data table that defines the two or more entities.

6. The method of claim 1, further comprising generating an entity-relationship (ER) model based, at least in part, on the two or more entities, the relationship, and the attribute.

7. The method of claim 6, further comprising converting the ER model into a set of program instructions to operate a processor-based system.

8. The method of claim 1, further comprising associating a particular attribute with a particular relationship in response to the user attempting to associate the particular attribute with an intended entity.

9. The method of claim 8, wherein the particular attribute and the intended entity are displayed in the display while the particular relationship is hidden from the display.

10. The method of claim 1, further comprising a method of generating a view, the method comprising:
automatically creating a database schema;
transforming an E-R graph into a menu that hides a level of complexity of the database schema; and
translating a user action on the menu into one or more page views that are viewable by developers and end users interacting with the application.

11. The method of claim 10, wherein the developers and the end users are exposed to the same one or more page views in a WYSIWYG fashion.

12. A method comprising:
receiving user input at a graphical user interface (GUI) to affect an application that defines data objects associated with two or more entities including a first entity and a second entity;
visually associating at the GUI an attribute with an entity in a display; and
associating the attribute with a relationship between and/or among the two or more entities including the first entity and the second entity in the application based, at least in part, on the visual association, wherein the relationship is hidden from the display.

13. An apparatus comprising:
a computing platform adapted to:
receive user inputs at a graphical user interface (GUI) to affect an application that defines data objects associated with two or more entities including a first entity and a second entity;
visually associate an attribute with the first entity in a display; and
establish a relationship between and/or among the two or more entities including the first entity and the second entity based, at least in part, on the visual association, wherein the second entity and the relationship are hidden from the user.

14. The apparatus of claim 13, wherein the computing platform is adapted to store the application on a server that is remote from the GUI.

15. The apparatus of claim 14, wherein the user input is received by the server via the Internet.

16. An article comprising:
a storage medium comprising machine-readable instructions stored thereon which, if executed by a computing platform, are adapted to cause said computing platform to:
receive user input at a graphical user interface (GUI) to affect an application that defines data objects associated with two or more entities including a first entity and a second entity;
visually associate at the GUI an attribute with the first entity in a display; and
establish a relationship in the application between and/or among the two or more entities including the first entity and the second entity based, at least in part, on the visual association, wherein the second entity and the relationship are hidden from the display.

17. The article of claim 16, wherein the application is stored on a server that is remote from the GUI.

18. The article of claim 17, wherein the user input is received by the server via the Internet.

19. The article of claim 16, the machine-readable instructions further adapted to generate an entity-relationship (ER) model based, at least in part, on the two or more entities, the relationship, and the attribute.

20. The article of claim 19, the machine-readable instructions further adapted to convert the ER model into a set of program instructions to operate a processor-based system.

21. An apparatus comprising:
a server hosting a system application adapted to define data objects associated with two or more entities including a first entity and a second entity, wherein the system application is adapted to build a custom application in response to a user input;
a memory disposed on the server adapted to storing the custom application;
a laptop computer including a display, a keyboard, a pointing device, a graphical user interface (GUI), and a browser, the laptop computer adapted to receive the user input to affect the system application and the custom application,
wherein the laptop computer is adapted to communicate with the server via the Internet using the browser,
wherein the browser is adapted to display to the user an image of each of the two or more entities,
wherein the browser is adapted to modify each of the two or more entities in response to said user input, and
wherein the GUI is adapted to visually associate an attribute with the first entity in the display in response to said user input; and
an Entity-Relationship (ER) model included in the system application adapted to define a relationship between and/or among the two or more entities including the first entity and the second entity based, at least in part, on the visual association, wherein the second entity and the relationship are hidden from the display.
